(19) United States
(12) Patent Application Publication
(10) Pub. No.: US 2003/0094331 A1
(43) Pub. Date: May 22, 2003

(54) Descent load apparatus preferably for persons, of the individual and portable type, that uses a mechanism to control the displacement, preferably through a chain used as descent line

(76) Inventor: Francisco Javier Vivanco Abarca, Santiago (CL)

Correspondence Address: Francisco Javier Vivanco Abarca, Palestrina 2960, San Joaquin, Santiago, 7041396, CL

(21) Appl. No.: 10/291,493

(22) Filed: Nov. 12, 2002

(30) Foreign Application Priority Data
Nov. 21, 2001 (CL) 2835 - 2001

(51) Int. Cl. A62B 1/10

(52) U.S. Cl. 182/234

(57) ABSTRACT

A descent apparatus, preferably for persons, of the individual and portable type, that is hooked or geared in sure and rapid form, with a chain, disposed in a vertical or pendulous form, whereby will be displaced, that offers the possibility to descend load, from high platforms, as buildings, steeps or any artificial or natural formation, that require and permit this type of operation. The design of this apparatus, is provided by a hooking hoop, to hang the harness, with the load to descend and an internal mechanism to brake, compounded by the combination of a pinion, pulleys, gears and a centrifugal brake, permit the controlled descent, uniform, autonomous and automatic, of one or more apparatuses, simultaneous and subsequently by a same line, may be used by persons, without knowledge or previous experience with this equipment, inclusive physically handicapped, or those with some degree of unconsciousness, with aid of third persons.

### BACKGROUND OF THE INVENTION

It exists a diversity of apparatuses and portable systems, denominated usually as descensders, that are employed for the individual descent of persons, through vertical descent lines. This variety of devices consists mainly on the utilization of harnesses, ropes, hoops, pulleys, hooks and special knots, which are triggered and controlled directly by the persons that descend. These apparatuses fulfil efficiently its function and they are normally used by industry, the assault forces, the rescue forces and the mountain sports organizations.

Although it is certain, these methods already known, have its kindness and fulfil effectively its objective, also present some disadvantages and inconvenients, that limit its efficiency and application, in direct prejudice of their user and above all in limit situations, as emergencies of various types.

All the descent systems known, by means of ropes, imply by its characteristic of design and drive, some degree of previous training and sufficient theoretical knowledge, which result to be an insuperable disadvantage, for all those neophyte persons in these matters, that with some degree of hysterics or nervous, with difficulty could employ this equipment and less yet, those persons with physical handicapped or definitely in unconsciousness condition.

Furthermore one must to consider, that all the descent methods by ropes, present some inconvenients, that they do not depend on the driving of the equipment, but on atmospheric conditions, in which neither the experts in its use, they can have absolute control, on unforeseen, as the accidental sliping, by dampness or grease of the rope. Also it should be consider the cut of the fibers by fret, or the fusion or combustion of the rope, by friction or exposition to the fire respectively, especially, when these are of synthetic manufacture.

On the other hand, all the descent methods assisted by third persons, through ropes, cables, chains or something similar, are yet slower, limiting drastically the quantity of rescued persons, due to all the steps that they should be followed, that consist basically, in taking one of these descent lines and tiing or hooking, to descend slowly and to release, to each one of these persons, for finally to wind or to recover the same line, to repeat the operation.

According to the previous, if is intended a massive rescue of persons, all these methods, turn out to be slow and complex, in circumstances that the time is scarce and the demand is high, as for example, a group of persons gathered in the roof of a building, during an emergency.

To conclude, the practices and the experience demonstrate, that the best and more useful rescue equipment, is the one, in which to the moment of be produced the emergency, already is found available in the place of the facts and in good conditions, with easy access and managing, with simple instructions, with low or void maintenance costs and few or no third persons assistance, for its utilization.

### SUMMARY OF THE INVENTION

It will be described a descent apparatus of the mechanical type, that offers an advantageous and novel form, for the descend of persons and/or objects, that effects this task of simple way, prompt, sure, uniform, controlled, autonomous and automatic, whose design results surprisingly practical and effective, in relationship to its antecedent.

### DESCRIPTION OF THE DRAWINGS

These advantages and other more, will remain in evidence in the following description, wherein:

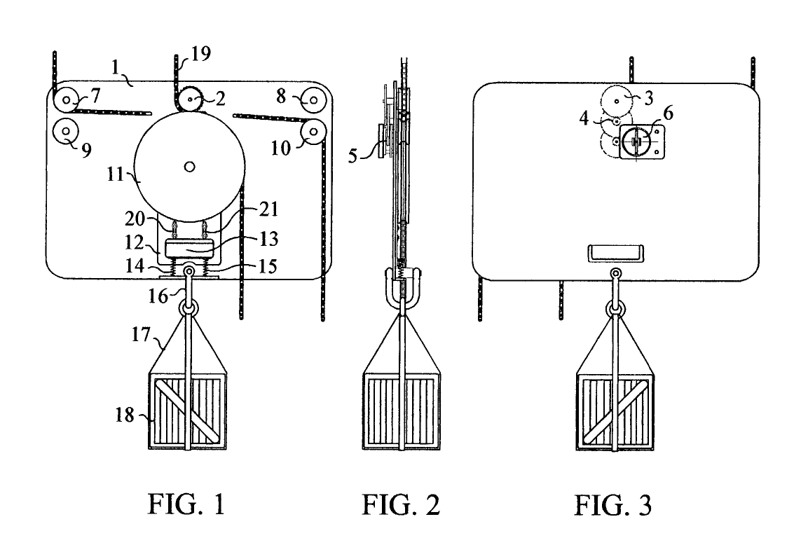

The FIG. 1 shows a view in elevation of the descent apparatus.

The FIG. 2 shows a left view of the descent apparatus.

The FIG. 3 shows a rear view of the descent apparatus.

Such as is shown in the FIGS. 1, 2 and 3, the invention, consists of an descent apparatus 1, with a preferably rectangular and flattened body, that serves as support and sustenance, for several mechanical elements, in which and for a better visualization of all these elements, it has been opted for representing the different views of the apparatus, without its corresponding lids and moldings, by not having these, a relevant function in its operation.

The pinion 2, located in the extreme superior of the body of the descent apparatus 1, is connected and has mechanical transmission, through its axis of rotation, with a first gear 3, that is geared with the second gear 4, of a landing gear, in the one which the last gear 5, is connected and has mechanical transmission, through its axis of rotation, with a centrifugal brake 6.

The pulley guide 11, is located between the pinion 2 and the hooking hoop 16, in the same plane and nearby to the pinion 2, but mounted in a mobile structure or approximation carriage 12, the one which is displaced by the grooves 20 and 21, and it is provided of two springs 14 and 15 and of a hilt 13.

The pulley 7 and the pulley 8, can be optional, and be fixed in its place, separated mutually both at each side of the pinion 2 and located in the same plane.

The pulley 9 and the pulley 10, can be optional, and be fixed in its place, separated mutually both at each side of the pulley guide 11, located in the same plane, faced and slightly separated of the pulleys 7 and 8 respectively.

The hooking hoop 16, is installed in the extreme inferior of the descent apparatus 1, in the same plane of the pinion 2, of the pulley 7, the pulley 8, the pulley 9, the pulley 10 and of the pulley guide 11, and is destined to hook the load 18, by means of the harness 17.

The chain 19 does not form solidary part of this descent apparatus 1, but that is complemented and worked in active form, with the pinion 2 and with the pulley guide 11 and optionally, with the pulley 7, the pulley 8, the pulley 9 or the pulley 10.

Neither form solidary part of this descent apparatus 1, the harness 17.

### DETAILED DESCRIPTION OF THE INVENTION

It will be described the general operation of the descent apparatus 1, to understand better the function, of each one of its components. In the FIGS. 1, 2 and 3, is shown a load 18 to descend, hung through a harness 17, in the hooking hoop 16, disposed in the body of the descent apparatus 1, that is sustained and is displaced by the chain 19.

Externally, the descent apparatus 1, consists of a pinion 2, a pulley guide 11, a pulley 7, a pulley 8, a pulley 9, a pulley 10, a hilt 13 and a hooking hoop 16, separated mutually and in a same plane, in which the pinion 2, is geared or hooked, with the chain 19, that hangs vertically, which will serve as flexible rack. The pulley guide 11 and optionally the pulley 7, the pulley 8, the pulley 9 or the pulley 10, will serve as a guide to deflect and to guide the displacement of the chain 19. The hooking hoop 16, has the basic function, of hanging the load 18, with the characteristic of being a mobile or floating element, but firmly hooked to the body of the descent apparatus 1, so that could to vary its gravity center in all the adopted positions.

The particular design distribution, of the different rolling elements of the descent apparatus 1 and because of the lever exercised, by the location of the hooking hoop 16, compel to the chain 19, to describe eventually a double curve, that permits to separate the section chain 19, near to the side of the harness 17.

According to the previous and depending on the elected combination, the descent apparatus 1, will permit fundamentally, six options of connection between this apparatus and the chain 19, in which the first two, consists of making the transit the chain 19, by the inferior left contour of the pinion 2 and the superior right contour of the pulley guide 11, or well the inferior right contour of the pinion 2 and the superior left contour of the pulley guide 11.

Upon adding the participation of the optional pulleys 9 and 10, are produced two new transit options, which consists in extending the previous transit of the chain 19, by the inferior left contour of the pinion 2 and the superior right contour of the pulley 10, or well the inferior right contour of the pinion 2 and the superior left contour of the pulley 9.

If at the already existing, it is added the participation of two new optional pulleys 7 and 8, without eliminating the pulleys 9 and 10, are produced two new transit options which consists in extending yet more the previous transit of the chain 19, those which consist of the transit of this, by the left inferior contour of the pulley 7, the inferior contour of the pinion 2 and the superior right contour of the pulley 10, or well the inferior right contour of the pulley 8, the inferior contour of the pinion 2 and the superior left contour of the pulley 9.

The previous has a great importance, because two extreme behavior alternatives can be presented, concerning the slope of the body of the apparatus descent 1, depending on the tension on the chain 19 and the weight of the load 18. That is to say that when the tension of the chain 19, is low and/or the weight of the load 18 is high, the chain 19 describes a double curve, modifying notoriously the primitive vertical straight line, before having been hung the load 18. Moreover when the tension of the chain 19, is high and/or the weight of the load 18 is low, the chain 19, will describe this double curve but less pronounced. At the end, in the two previous cases and in all the intermediate cases, the separation between the load 18 and chain 19, it will be always of an adequate minimum, without importing the weight-tension relationship.

The descent apparatus 1, has a system of fixation for the chain 19, compound by a hilt 13, that displaces in a short distance the pulley 9, that furthermore to deviate the chain 19, has other important purpose is that assuring its correct gear with the pinion 2. The pulley guide 11, in its rest condition, stays near to the pinion 2, at a distance similar to the width of the chain 19. When it is effected the approximation between the descent apparatus 1, with the chain 19, the pressure manually applicated, to the hilt 13, draws from its rest condition to the pulley guide 11 and permits that the chain 19, would been placed in its workplace, gearing correctly with the cogs of the pinion 2, then after accomplishing this hooking operation, the elimination of the pressure on the hilt 13, will permit that the pulley guide 11, by means of the springs 14 and 15, recovers its normal rest condition, imprisoning the chain 19, in against of the pinion 2. For the disconnection of the descent apparatus 1, with the chain 19, it should be repeated the same operation, with the hilt 13.

According to the previous and by its symmetrical design, the descent apparatus 1, offers the possibility, of a correct connection, with the chain 19, in any position elected by the user.

Internally, the descent apparatus 1, has a reducing box, compound by a landing gear, that fulfils the function of reducing the torque of the pinion 2. At the end of this landing gear, in which the power of torque is reduced and the draft speed is high, a centrifugal brake 6 system is provided, that by its mass and diameter, serves as a stabilizing balance wheel, that complies with the delicate task of stabilizing and maintaining a specify and constant speed, what finally will be result, in a vertical displacement speed, uniform and constant in the descenst apparatus 1.

The importance of maintaining a stable descend speed, and having an uniform and defined calibration of each one of these apparatus, will permit in the magnitude of the resistance of the chain 19, the simultaneous descent of several of this, in sequence. That is to say that they will be able to hook an after other, several persons or objects, independently of its weight, those which because of the characteristics design of the descent apparatus 1, will maintain a stable and uniform descent speed, therefore a separation, also stable and uniform between each person, until the end of the way. What is very beneficial for the massive rescue intentions.

Other aspect of vital importance is that, by the fact of that the descent line will be a chain 19, with links that they can be geared, or in its substitution a rack, that will not permit an undesirable slip, once hooked the descent apparatus 1, in case of existing such event, it would be disastrous during the displacement, for that load or person and those of more down.

All the previous description, base its arguments, in experiences accomplished in outdoors platforms, with a basic prototype, that used the sufficient elements, to demonstrate its good and correct operation. That is to say that in these tests, intervened the principal elements as, a flattened body 1, a chain 19, a pinion 2, a pulley guide 11, a pulley 7, a pulley 8, a pulley 9, a pulley 10, a train of gears and a centrifugal brake 6.

With the previous prototype and a simulated load, was proved the performance of this apparatus, that permitted to elaborate the present descriptive report, wherein was put all the obtained information, for a better comprehension to the qualities of this invention.

What I claim as my invention is:

1. A descent load apparatus preferably for persons, of the individual and portable type, that uses a mechanism to control the displacement, through a chain used as descent line, comprising:
a body having preferably flattened and rectangular form, wherein, externally are located and worked, aligned in its transverse axis and in a same plane, preferably a pinion, a guide pulley and a hooking hoop with the load, more four optional pulleys, located also in the same plane, but one to each side of the pinion and of the guide pulley; wherein the pinion, that is located in an extreme of the flattened body and very nearby the guide pulley, that both together and because of an approximation system between both, admit, gear and assure the chain, preferably of the type of transmission, pendulous or vertically installed, compelling it to describe eventually, a double curve of transit, by effect of the slope of the apparatus, because of the load; having four optional pulleys, from which, one or more of them united to the pinion, compel to the chain, to describe two curves, but more separated between both; being located also in the body of the apparatus, but in its other extreme, preferably a mobile or floating hoop, for the hooking of the load; existing furthermore, a transmission, through the rotation's axis of the pinion, that sustains the weight of the apparatus more the load, with an internal mechanism, that brakes its rotation, composed preferably, by a reducing gears train of torque and a centrifugal brake, which by its mass and diameter, serves as stabilizing steering wheel.

2. The descent load apparatus of claim 1, wherein the location of the three elements, constituted by the pinion, the guide pulley and the hooking hoop, presents a non-linear geometric configuration.

3. The descent load apparatus of claim 1, wherein the exchange of places and functions, between the pinion and the guide pulley, produces the same desirable effect.

4. The descent load apparatus of claim 1, wherein the exchange of places and functions, between the pinion and anyone of the optional pulleys, produces the same desirable effect.

5. The descent apparatus of claim 1, wherein has more than of a pinion, to hook the chain, being able to be linked and synchronized mutually, by the use a transmission chain or gears, destinated to replace the position and function, of anyone of the guide pulleys and/or optional pulleys, producing the same desirable effect

6. The descent load apparatus of claim 1, wherein one or more of the optional pulleys, can be mounted in the same approximation carriage, and fulfil the double function of guiding and assuring the descent line.

7. The descent load apparatus of claim 5, wherein one or more of the pinions, can be mounted in the same approximation carriage, and the guide pulley and/or one or more of the optional pulleys, fixed in the apparatus.

8. The descent load apparatus of claim 1, wherein the descent apparatus, can descend persons, animals, objects and all type of load.

9. The descent load apparatus of claim 1, wherein the descent line, is a chain of links the conventional type composed of hoops.

10. The descent load apparatus of claim 9, wherein the element that gears with the chain, is a caged pulley, engraved or something similar, appropriate for this type of chain.

11. The descent load apparatus of claim 1, wherein the descent line, is a chain of beads or a modified version of this, but that produces the same effect.

12. The descent load apparatus of claim 11, wherein the element that gears with the chain, is a caged pulley, engraved or something similar, appropriate for this type chain.

13. The descent load apparatus of claim 1, wherein the descent line, is a rack or a modified version of this, but that produces the same effect.

14. The descent load apparatus of claim 13, wherein the element that gears with the rack, is a gear.

15. The descent load apparatus of claim 1 and 14, wherein the element that gears with the chain or with the rack, is a mixed version of a pinion and a gear.

16. The descent load apparatus of claim 1, wherein the descent line, in a cable or common rope, or a modified version of these, provided of ruggednesss or uniform knobs, with reminiscences of a chain or a rack.

17. The descent load apparatus of claim 16, wherein the element that gears or wherein partially is coiled this cable or rope, is a modified pulley, with interior abrasive walls, fluteed, engraved or caged.

18. The descent load apparatus of claim 1, wherein the reducing mechanism of torque, is constituted by the gears combination, whose configuration, is of the conventional type, in the form of train or cascade.

19. The descent load apparatus of claim 1, wherein the reducing mechanism of torque, is constituted by the gears combination, whose configuration, is of the satellite type.

20. The descent load apparatus of claim 1, wherein the reducing mechanism of torque, is constituted by the combination of pinions and chain of transmission.

21. The descent load apparatus of claim 1, wherein the reducing mechanism of torque, is constituted by the combination of wreath and endless screw.

22. The descent load apparatus of claims 18, 19, 20 and 21, wherein the reducing mechanism of torque, is constituted by the combination of two or more of these reduction methods.

23. The descent load apparatus of claim 1, wherein the centrifugal brake, is of the conventional type, of friction by fret surfaces.

24. The descent load apparatus of claim 1, wherein the centrifugal brake, is of the magnetic type, of magnetic fields interference.

25. The descent load apparatus of claims 23 and 24, wherein uses springs, as force opposed to the centrifugal effect.

26. The descent load apperatus of claims 23 and 24, wherein uses magnets, as force opposed to the centrifugal effect.

27. The descent load apparatus of claim 1, wherein the regulatory speed brake, is a rotor controlled in electromagnetic or magnetic form, through electrical or electronic circuits.

28. The descent load apparatus of claim 1, wherein the descent load apparatus, has at least, one movement detector system, through the descent line, being able to be this, of optical type, magnetic, mechanical or something similar, to control its displacement or for any other useful end, for the best operation of the apparatus.

29. The descent load apparatus of claim 28, wherein the movement detector system of the apparatus, can be also in the descent line, for screening the displacement, of one or more apparatus in transit in a same line, or for any other useful end, for the best operation of the apparatus.

30. The descent load apparatus of claim 1, wherein in some phase of its mechanism, has a mechanical connection, to a dynamo or electrical generator, to control electrical or electronically, the decrease speed and/or for signers luminous, sonorous, mobile, radio frequency generation, or for any other useful end, for the best operation of the apparatus.

31. The descent load apparatus of claim 1, wherein in its external part, has instructions, signalings or marks colored, holographic, reflective, fluorescent and/or phosphorescent, for any useful end, for the best operation of the apparatus.

32. The descent load apparatus of claim 1, wherein the descent load apparatus, has a regulatory system or manual selector of displacement speed, incorporated to the mechanism of the apparatus.

33. The descent load apparatus of claim 1, wherein the descent load apparatus, has a manual brake system, incorporated to the mechanism of the apparatus.

34. The descent apparatus of claim 1, wherein in some phase of its internal mechanism, has a mechanical connection option, toward the external part of the apparatus, to install an indicator, a crank, a motor, or a synchronization's shaft of displacement, connected to one or more similar descent apparatus, or for any other useful end, for the best operation of the apparatus.

35. The descent apparatus of claim 34, wherein the descent load apparatus has the possibility of ascending, by the descent line, because of its external connection option, through the application of human force, electromotive or the appropriate force for these effects.

36. The descent apparatus of claim 1, wherein the descent load apparatus, has sufficient and adequate electrical insulation, between the apparatus and/or the harness, in relation to the load.

37. The descent apparatus of claim 34, wherein the descent load apparatus, has an internal electrical motor, for its vertical displacement, fed by internal or external batteries, or well fed by electrical energy through the same descent line, when this is metallic and by the other conducting part of the structure of the building, destined for the effects of closing the electrical circuit.

38. The descent apparatus of claim 37, wherein the descent load apparatus has a compartment preferably with lid, for multiple purposes, being able to house batteries, instructions, an appropriate size harness, tools or any other type of object, for a better operation of the apparatus.

39. The descent apparatus of claim 37, wherein the descent load apparatus has appropriate electronic or electrical plugs, to connect and transmit, power and/or signal, from and toward the interior of the apparatus, to connect with other equipment or accessory, or well with other descent apparatus equal or similar.

40. The descent apparatus of claim 1, wherein the descent load apparatus has all the moldings, lids or necessary external structures, to protect and/or to permit a correct operation of the apparatus.

41. The descent apparatus of claim 1, wherein all its mobile parts, can be mounted in traditional shafts with bearings or self-lubricate bushings.

42. The descent apparatus of claim 41, wherein all its mobile parts or part of they, can be mounted in dry shafts, without need of lubrication, in undefined periods, or to it less very vast.

43. The descent apparatus of claim 1, wherein one or more, of the principal elements, pinion, guide pulley, optional pulleys and hooking hoop, can be installed in mobile arms, telescopic and/or foldable, that from its rest state, storage or transportation, can be projected from the body of the apparatus, for its work position.

44. The descent apparatus of claim 43, wherein its external forms, preferably in a flattened and/or paralelepiped form, permit an easy and practical, storage and transportation manner.
